(19) United States
(12) Patent Application Publication
(10) Pub. No.: US 2016/0150262 A1
(43) Pub. Date: May 26, 2016

(54) AUDIO VISUAL SMARTPHONE BROADCASTER

(71) Applicants: Greg VanCuren, Fremont, IN (US); Aaron VanCuren, Fremont, IN (US)

(72) Inventors: Greg VanCuren, Fremont, IN (US); Aaron VanCuren, Fremont, IN (US)

(21) Appl. No.: 14/549,148

(22) Filed: Nov. 20, 2014

(51) Int. Cl. H04N 21/41; H04N 21/4363; H04N 21/436

(52) U.S. Cl. CPC H04N 21/4126; H04N 21/4122; H04N 21/43615; H04N 21/43637

(57) ABSTRACT

An information transfer system including a personal electronic device, at least one television, and at least one signal broadcasting device. The signal broadcasting device transfers information from the television to the personal electronic device, and includes a signal input and a processing apparatus. The signal input is coupled to a television output to thereby provide an audio/visual signal containing the information. The audio/visual signal corresponds to a selected channel being displayed on the television. The processing apparatus receives the audio/visual signal and provides a wireless output signal containing a portion of the audio/visual signal to the personal electronic device.

### BACKGROUND OF THE INVENTION

1. Field of the Invention

The present invention relates to an electronic interface, and, more particularly, to an interface that receives audio-visual inputs from a television.

2. Description of the Related Art

With the unrelenting popularity of electronic devices, a person may own a variety of handheld devices, such as, a mobile phone, a portable media player, a digital camera, a digital video recorder, a handheld game console, a global positioning system (GPS), a notebook/netbook PC, and even other devices. Each device may have its own built-in audio-visual input/output module for receiving and/or transmitting information.

Many standard interfaces have been adopted for use by the designers of video input/output modules. For example, interfaces such as ITU-R 601/656, MIPI CSI-2, SMIA CCP-2, MDDI, MIPI DSI, USB and HDMI are widely used. The use of proprietary interfaces of the handheld devices sometimes pose a problem for sharing video among handheld devices.

A typical handheld device includes a plurality of interfaces for external signals and devices, such as, a video input module, a universal serial bus (USB), an interface connector for an earphone and a microphone, a connector for charging the battery, a memory card slot, a composite video output interface, and a key pad module. In addition, some handheld devices may include an audio/video input for recording and playing back, as well as a video output interface for transmitting audio/video to external devices, such as, a TV or a projector.

What is needed in the art is an easy to operate, and inexpensive system that provides an audio-visual signal to a personal electronic device.

### SUMMARY OF THE INVENTION

The present invention provides a system and method of directing a channel selected on a television to a smartphone.

The invention in one form is directed to an information transfer system including a personal electronic device, at least one television, and at least one signal broadcasting device. The signal broadcasting device transfers information from the television to the personal electronic device, and includes a signal input and a processing apparatus. The signal input is coupled to a television output to thereby provide an audio/visual signal containing the information. The audio/visual signal corresponds to a selected channel being displayed on the television. The processing apparatus receives the audio/visual signal and provides a wireless output signal containing a portion of the audio/visual signal to the personal electronic device.

The invention in another form is directed to a signal broadcasting device having a signal input configured to be coupled to an output of a television to thereby receive an audio/visual signal from the television containing information, the audio/visual signal corresponding to a selected channel being displayed on the television. The signal broadcasting device also having a signal processing apparatus configured to receive the audio/visual signal and provide a wireless output signal containing at least a portion of the audio/visual signal to a personal electronic device.

The invention in yet another form is directed to an information transfer method including the step of transferring information from at least one television to a personal electronic device using a signal broadcasting device. The signal broadcasting device executes the steps of receiving and processing. The receiving step includes the receiving of information in the form of an audio/visual signal by way of a signal input coupled to a television output of the television. The audio/visual signal corresponds to a selected channel being displayed on the television. The processing step includes the processing of the audio/visual signal and providing a wireless output signal containing at least a portion of the audio/visual signal to the personal electronic device.

An advantage of the present invention is that the audio-visual feed of a television is sent to a smartphone to thereby enhance the user's ability to enjoy the programming.

Another advantage of the present invention is that other information can be tagged onto the feed to provide information to the user.

Yet another advantage of the present invention is that the audio output of the smartphone may be used with ear buds to enhance the sound from the television feed.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates in a schematic form an embodiment of an information transfer system of the present invention; and

FIG. 2 illustrates in a schematic form an interaction between one personal electronics device and one television selected by the system of FIG. 1.

Corresponding reference characters indicate corresponding parts throughout the several views. The exemplification set out herein illustrates one embodiment of the invention and such exemplification is not to be construed as limiting the scope of the present invention in any manner.

### DETAILED DESCRIPTION OF THE INVENTION

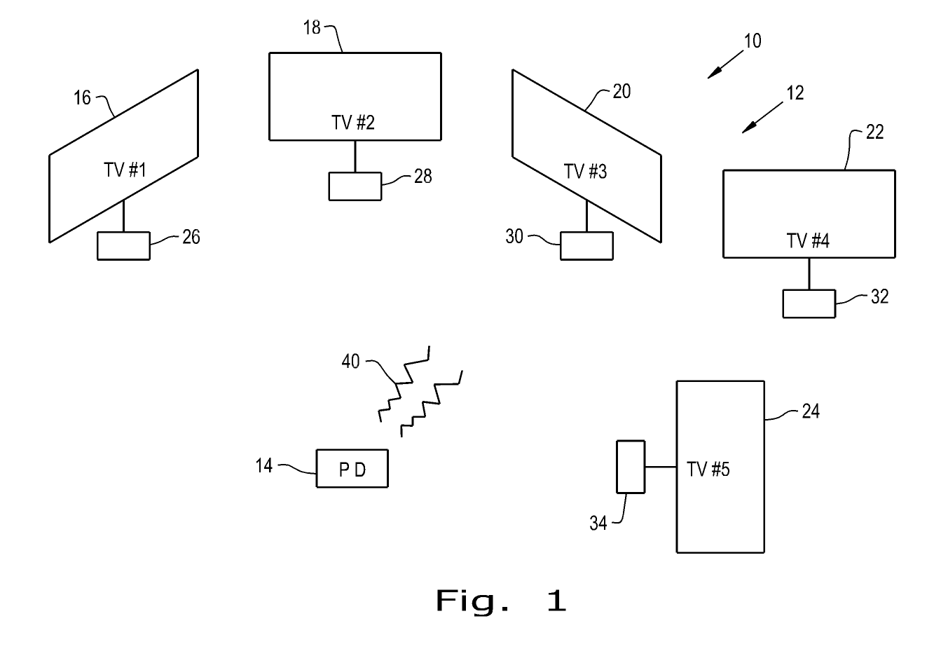

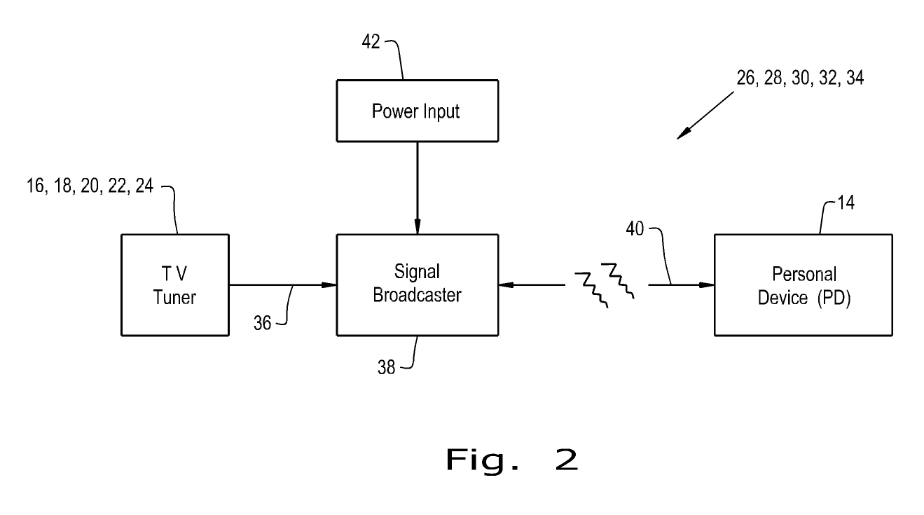

Referring now to the drawings, and more particularly to FIGS. 1 and 2, there is shown an embodiment of an information transfer system 10 that may, for example, take place in a sports bar 12 (or a fitness center or other place where the public display of television shows take place). Information transfer system 10 includes a personal electronic device 14, for example in the form of a smartphone 14 that receives audio-visual information from a channel being displayed on one of the televisions 16, 18, 20, 22, 24 illustrated in FIG. 1 as TV#1-5, which may denote how each TV is identified to the user of smartphone 14. Signal broadcasting devices 26, 28, 30, 32, 34 are respectively associated with televisions 16, 18, 20, 22, 24 and receive audio-visual information from the respective TVs that correspond to a channel being displayed on the screen of that particular TV.

Signal broadcasting devices 26, 28, 30, 32, 34, each have a signal input 36 and a signal processing apparatus 38 for the receipt and processing of the audio-visual signal, and transmittal of an output signal 40. A power input 42 supplies operational power to signal broadcasting devices 26, 28, 30, 32, 34.

To further explain and illustrate the present invention an example of a user in a sports bar 12 will be used. For example, a user enters sports bar 12 and selects TV#3, which is displaying the user's favorite sporting event/team, the process includes selecting TV#3 on smartphone 14 to thereby couple smartphone 14 with signal processing device 30. At least a portion of the audio-visual signal from TV#3 is sent by way of output signal 40 to smartphone 14, depending on the needed resolution. In a like manner other patrons of sports bar 12 can couple their smartphones to their selected TV#. The users can then watch and/or listen to their selected event, even if the volume on the TV is turned down or if the particular view to the TV from the user's seat is not particularly good.

The selection process may simply be by noting an identifying mark (such as TV# . . . ) located near the TV, or there may be a broadcast reference from signal broadcasting devices 26, 28, 30, 32, 34 that indicate the teams that are playing, or the title of the program. Alternatively, a thumbnail of each of the broadcasts might be displayed from information from each of TV#1-5, so that the user can select the desired TV feed. It is also contemplated that a separate device may supply the thumbnails as well as other interactions with smartphone 14 and an employee of sports bar 12.

If an employee of sports bar 12 changes a channel, of course this will change the feed going to those users that are coupled to a specific TV. It is also contemplated that signal broadcasting devices 26, 28, 30, 32, 34, may receive information from the sports bar employee, such as a text or a short audio/visual alert that some event has occurred, such as “there are fresh Cajun wings on the buffet”, and that this message will be displayed on the smartphones of all, or some of the patrons. It is also contemplated that information transfer system 10 may keep the sports bar employee informed as to who or how many are connected to information transfer system 10 and their particular TV selections. If the Grand Knitting Championship on TV#4 is being totally ignored then the employee can change the channel to the Patriots game.

It is further contemplated that the user of smartphone 14 can participate in a voting scenario to select a displayed feature on a TV. For example, a local group of rugby enthusiasts might arrive at sports bar 12 and they sign onto information transfer system 10 and by demand, as evidenced by their signing on with a desired game request, the employee can choose to air a rugby match of their choice, and have this group coupled to that particular TV. Alternatively, the present invention may even allow the automatic selection of a particular TV feed, so it is contemplated that a menu of available feeds may be sent to smartphone 14 for user voting that can result in an automatic selection of the TV feed.

It is further contemplated that food menu selections may be sent to smartphone 14, so that ordering may take place by way of information transfer system 10. Further, billing and paying arrangements may take place by way of information transfer system 10.

Signal input 36 may be in the form of an HDMI, a USB, A/V cable, and audio jack connection, which is generally a hardwired or at least a direct connection. Power may be also supplied to signal broadcasting devices 26, 28, 30, 32, 34 by way of the signal input depending on the type of connection used. Signal output 40 is a wireless signal, which may be a Bluetooth® or Wi-Fi signal or the like.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An information transfer system, comprising:
a personal electronic device;
at least one television; and
at least one signal broadcasting device transferring information from said at least one television to said personal electronic device, said signal broadcasting device including:
a signal input coupled to a television output of said television to thereby provide an audio/visual signal containing the information to said signal input, the audio/visual signal corresponding to a selected channel being displayed on said television; and
a signal processing apparatus configured to receive the audio/visual signal and provide a wireless output signal containing at least a portion of the audio/visual signal to said personal electronic device.

2. The information transfer system of claim 1, wherein said personal electronic device outputs at least some of the information by way of at least one of a speaker and a display to a user.

3. The information transfer system of claim 1, wherein said at least one television is a plurality of televisions including a first television and a second television, said at least one signal broadcasting device being a plurality of signal broadcasting devices including a first signal broadcasting device and a second broadcasting device, said first signal broadcasting device being associated with said first television, said second signal broadcasting device being associated with said second television, said personal electronic device being configured to display both the audio/visual signal from said first signal broadcasting device and the audio/visual signal from said second broadcasting device at the same time.

4. The information transfer system of claim 3, wherein said personal electronic device is further configured to select between the audio/visual signal of said first signal broadcasting device and the audio/visual signal of said second signal broadcasting device to thereby be the information that is displayed on said personal electronic device.

5. The information transfer system of claim 4, wherein said wireless output signal is a Wi-Fi signal and/or a Bluetooth® signal.

6. The information transfer system of claim 4, wherein said signal input is directly connected to said television output.

7. The information transfer system of claim 4, wherein said personal electronic device is a smartphone.

8. The information transfer system of claim 1, wherein said at least one television is a plurality of televisions including a first television and a second television, said at least one signal broadcasting device being a plurality of signal broadcasting devices including a first signal broadcasting device and a second broadcasting device, said first signal broadcasting device being associated with said first television, said second signal broadcasting device being associated with said second television, said personal electronic device being configured to display a first identifier associated with said first television and a second identifier associated with said second television, said personal electronic device being further configured to allow a user selection of either said first identifier or said second identifier to thereby respectively select the information from the first television or the second television to be displayed on said personal electronic device.

9. A signal broadcasting device, comprising:
a signal input configured to be coupled to an output of a television to thereby receive an audio/visual signal from the television containing information, the audio/visual signal corresponding to a selected channel being displayed on the television; and
a signal processing apparatus configured to receive the audio/visual signal and provide a wireless output signal containing at least a portion of the audio/visual signal to a personal electronic device.

10. The signal broadcasting device of claim 9, wherein the personal electronic device is configured to output at least some of the information from the signal broadcasting device by way of at least one of a speaker and a display to a user.

11. The signal broadcasting device of claim 9, wherein said wireless output signal is a Wi-Fi signal and/or a Bluetooth® signal.

12. The signal broadcasting device of claim 9, wherein said signal input is directly connected to the television output.

13. The signal broadcasting device of claim 9, wherein the personal electronic device is a smartphone.

14. An information transfer method, comprising the steps of:
transferring information from at least one television to a personal electronic device using a signal broadcasting device, the signal broadcasting device:
receiving information in the form of an audio/visual signal by way of a signal input coupled to a television output of the television, the audio/visual signal corresponding to a selected channel being displayed on the television; and
processing the audio/visual signal and providing a wireless output signal containing at least a portion of the audio/visual signal to said personal electronic device.

15. The method of claim 14, wherein said personal electronic device outputs at least some of the information by way of at least one of a speaker and a display to a user.

16. The method of claim 14, wherein said at least one television is a plurality of televisions including a first television and a second television, said at least one signal broadcasting device being a plurality of signal broadcasting devices including a first signal broadcasting device and a second broadcasting device, said first signal broadcasting device being associated with said first television, said second signal broadcasting device being associated with said second television, said personal electronic device being configured to display both the audio/visual signal from said first signal broadcasting device and the audio/visual signal from said second broadcasting device at the same time.

17. The method of claim 16, wherein said personal electronic device is further configured to select between the audio/visual signal of said first signal broadcasting device and the audio/visual signal of said second signal broadcasting device to thereby be the information that is displayed on said personal electronic device.

18. The method of claim 17, wherein said wireless output signal is one of a Wi-Fi signal and s Bluetooth® signal.

19. The method of claim 17, wherein said signal input is directly connected to said television output.

20. The method of claim 14, wherein said at least one television is a plurality of televisions including a first television and a second television, said at least one signal broadcasting device being a plurality of signal broadcasting devices including a first signal broadcasting device and a second broadcasting device, said first signal broadcasting device being associated with said first television, said second signal broadcasting device being associated with said second television, said personal electronic device being configured to display a first identifier associated with said first television and a second identifier associated with said second television, said personal electronic device being further configured to allow a user selection of either said first identifier or said second identifier to thereby respectively select the information from the first television or the second television to be displayed on said personal electronic device.
